(19) United States
(12) Patent Application Publication
(10) Pub. No.: US 2007/0095446 A1
(43) Pub. Date: May 3, 2007

(54) Tyre revolution counter

(76) Inventors: Federico Mancosu, Milano (IT); Franco Festa, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/536,403

(22) PCT Filed: Dec. 20, 2002
(86) PCT No.: PCT/EP02/14650

§ 371 Date: Dec. 1, 2006

(51) Int. Cl. B60C 23/06; G01P 15/02

(52) U.S. Cl. 152/152.1; 73/146

(57) ABSTRACT

A pneumatic tyre includes a sensor device for monitoring one or more dynamic parameters of the tyre and a detecting device. The sensor device is disposed in a crown portion of the tyre and includes an inertial switch. The inertial switch changes from a first state to a second state when the crown portion begins contacting a ground surface and changes from the second state to the first state when the crown portion loses contact with the ground surface. The detecting device is operatively connected to the inertial switch and determines the one or more dynamic parameters of the tyre from a signal obtained from the changes of the inertial switch. A method for monitoring the one or more dynamic parameters includes providing the tyre with the sensor device disposed in the crown portion, rotating the tyre on the ground surface, and determining the one or more dynamic parameters.

The present invention relates to a method for monitoring at least one dynamic parameter of a pneumatic tyre during use, and to a tyre including a sensor adapted for monitoring said at least one dynamic parameter. More particularly, the present invention relates to a method for counting revolutions of a pneumatic tyre during use, and to a tyre including a sensor adapted for counting tyre revolutions.

It has already been proposed to remotely monitor conditions of pneumatic tyres of motor vehicles. For example telemetry devices comprising a radio-frequency (RF) transmitter and one or more condition sensors may be disposed in each of the tyres of the vehicle. A transponder and associated condition sensors (e.g., pressure, temperature) may also be disposed in pneumatic tyres of motor vehicles. A “transponder” is an electronic device capable of both receiving and transmitting RF signals. These transponders transmit a RF wave, with or without variable data (e.g., pressure, temperature) and/or fixed data (e.g., tyre identification code) to outside the tyre. A separate transponder is typically associated with each tyre of a motor vehicle to monitor and transmit tyre-related data. Typically, a single “interrogator” having both transmitting and receiving capabilities is used to communicate with the plurality of transponders. The interrogator may be hand-held, or mounted on-board the vehicle, or positioned along or in a roadway. In the context of the present invention, both telemetry and transponder devices included in a pneumatic tyre for the above purposes will be generally referred with the expression “sensor (or sensing) devices”.

In particular, “active” sensor devices have their own power supply (e.g., a battery). They transmit signals, and may typically be also capable of receiving signals to control their functionality. “Passive” sensor devices are powered by the energy of an incoming RF signal, such as from an interrogator.

For example, currently available tyre pressure monitoring systems (TPMS) perform real time sensing of the pressure inside the tyre. A sensing device is located in the tyre and is comprised of a pressure sensor, a signal processor, and a RF transmitter. The pressure measurement information is then carried and displayed to the driver in the cabin of the vehicle. The system compensates pressure variations due to temperature, so that a temperature sensor is also provided. The power supply is typically provided by a long life battery that an embedded intelligence helps to manage as effectively as possible. The receiver could be either dedicated to TPM use, or shared with the other functions in the vehicle. To improve the battery management, an inertial switch can be employed to detect the parking mode.

Tyre revolution counters attached to tyres have already been proposed. For example, U.S. Pat. No. 4,862,486 discloses that a tyre revolution for passenger, light truck, truck and off-road vehicles can be determined and counted by an apparatus comprising a piezoelectric polymer sensor which senses a change in stress as a given section of the tyre is stressed with each tyre revolution. The apparatus comprises an elastomeric component which flexes with the tyre. The elastomeric component permits a piezoelectric polymer sensor to detect the flexing of the tyre as well as to adhere the apparatus to the tyre. When the sensor detects a change in stress it sends an electrical charge to a counter circuit. The apparatus is mounted to the inner sidewall of a tyre and adheres to the inner sidewall in the same manner as a conventional tyre puncture repair patch.

PCT patent application no. WO 00/02741 discloses a self-powered tyre revolution counter. A piezoelectric (“piezo”) element is mounted in the tyre in a manner so as to be subjected to periodic mechanical stresses as the tyre rotates and to provide periodic pulses in response thereto. The output of the piezo element is utilized by revolution counting circuitry to count rotations of the tyre, as well by power circuitry which provides power to the revolution counting circuitry.

U.S. Pat. No. 5,749,984 discloses that using a sensor device which varies its output as a particular point on the circumference of the tyre enters and exits the contact patch lends itself to digital values with respect to the time. Tyre deflection can then be calculated using the ratio of the time spent in the contact patch to time spent traveling around the circumference of the tyre. A digitized electrical signal also provides the number of tyre rotations per unit of time (rotational frequency) as well as the total number of revolutions over the life of the tyre. According to the '984 patent, a sensor device used to provide a signal for calculating tyre contact patch length can comprise one of several different types, including: a piezoelectric polymer; a photoresistive fiber optic cable connecting a light emitting diode and a photocell, which modulates the amount of light received by the photocell when the fiber optic cable is bent normal to its longitudinal axis; a variable capacitor made from aluminized mylar, whose capacitance changes as a function of pressure; a variable inductor sensor, consisting of an inductive coil whose inductance changes or whose coupling between two inductive coils changes as a result of sensor strain. The sensor device is positioned on an inside surface of the tyre. The monitored reference point is adjacent the sensor device on the external surface of the tyre tread at the radial plane. Large deformations of the sensor device occur as the reference point enters contact with the ground surface. The strain of these first deformations produces an electrical signal having a maximum value followed by a minimum value before the tread surface becomes flat on the ground surface. As the reference point leaves the contact area the sensor device is again strained and a second deformation produces another electrical signal having another maximum value and another minimum value. The first and second deformations of the sensor device as the reference point enters and exits the contact patch define the contact length. First and second electrical signals are converted to first and second electrical clock pulses respectively. The electrical pulses are used as input into a digital counting circuit, which uses the converted sensor electrical pulses to count the number of revolutions which occur for any given monitoring time period.

PCT patent application no. WO 98/56606 discloses a method for monitoring a running motor vehicle wheel tyre, and, in particular, a device comprising a sensor mounted on the wheel, coupling means transmitting to the vehicle indications obtained from the sensor and power supply means. More particularly, an accelerometer is preferably placed in the tyre tread. An electronic circuit is associated to the accelerometer. The authors consider a tyre having a radius R traveling at a speed V. A tyre portion BC, having a length L, is in contact with ground, under load. In a point A, outside the portion BC, the centrifugal radial acceleration is V²/R. On the other hand, between the points B and C the centrifugal radial acceleration is substantially zero, in that the differential speed of the tyre with respect to the ground is substantially zero. By implanting an accelerometer within the tyre, the portion BC can be detected. The passage of the centrifugal acceleration to a substantially zero value allows to temporally identify the whole of the portion BC. The acceleration is practically zero in a time interval TL, which corresponds to the passage of the accelerometer between the points B and C, and have a strong value during the remaining of the time, as far as the vehicle travels at a speed of several km/h. The rotation period of the tyre is also given by the measures. The number of tyre revolutions in a given time T can also be determined, corresponding to the kilometers traveled by the tyre in the given time T.

According to the Applicant, the distance traveled by a pneumatic tyre is a very important parameter to be carefully checked and monitored in order to plan a maintenance of the tyre or its substitution. Too long traveled distances may result in low safety, due, for example, to imperfections occurred in the internal tyre structure (e.g., in the tyre carcass). Typically, vehicles include devices capable of measuring the traveled distance. However, the distance traveled by a vehicle does not necessarily correspond to the distance traveled by its tyres. As a matter of fact, a measure of the traveled distance performed in this way does not take into account of periodical substitutions of the tyres. For example, in many countries it is highly advisable to seasonally replace the tyres mounted on vehicles, due to the different environmental conditions.

The monitoring of the distance traveled is of particular importance for tyres suitable for heavy duty vehicles, such as trucks, road haulage vehicles, vehicles used for quarry and construction work, coaches for transporting persons, etc. These types of vehicles are often organized in fleets, managed by fleet managers. A fleet manager should always have at his disposal a complete report about the status of the tyres of the whole fleet, with particular reference to the distance actually traveled by the tyres. However, a fleet may be comprised of a high number of vehicles. Monitoring the conditions of the tyres of the vehicles belonging to the fleet may be a complex issue for the fleet manager, with an increasing complexity corresponding to the increasing number of vehicles. For example, for such tyres it is currently the practice to replace a totally worn tread band with a new tread band by means of processes which are generally called “recapping” or “remoulding”. In such case, a tyre being visually “new” (i.e., having a new tread band) may actually have traveled a significant distance: this may cause considerable safety problems, due to possible imperfections in the internal structure of the tyre. Furthermore, the tyres mounted on the vehicles of a fleet have to be often changed in order to cope with different road conditions, and/or distances to be covered. In such conditions, it is practically impossible to rely on a measure of the distance traveled by the tyres of the fleet given by devices put on the vehicles.

The Applicant has observed that all the above proposed methods and apparatuses for monitoring dynamic parameters of a tyre (e.g. for counting tyre revolutions) always rely on dedicated sensors, such as a piezo sensor, or an accelerometer, or another component, to be placed together with its control electronics within the tyre. This increases complexity, weight and cost of the sensing device. Furthermore, as a matter of fact, any new component introduced within a sensing device to be inserted within a tyre may strongly reduce its reliability and duration over time.

The Applicant has faced the problem of realizing a sensing device to be inserted within a tyre, capable of monitoring dynamic parameters of the tyre, such as the number of tyre revolution in a given time interval during rolling, and having a reliable, cheap and simple structure.

The Applicant has found that such problem can be solved by using an inertial switch included within a sensor device located in a crown portion of the tyre, as described herein below. When the crown portion corresponding to the position of the sensor device is not in contact with the ground, the inertial switch is subject to a centrifugal acceleration, whose value depends on the rotation speed of the tyre. In such conditions, the inertial switch is in a first state (for example, it is in a closed state). When the crown portion corresponding to the position of the sensor device comes in contact with the ground, the centrifugal acceleration to which the inertial switch is subjected drops to a substantially null value. The inertial switch then performs a first switching action to a second state, due to such sudden change of centrifugal acceleration value (e.g., it changes to open state, in the above example). When the crown portion corresponding to the position of the sensor device looses contact with the ground, the centrifugal acceleration to which the inertial switch is subjected changes again, raising to a high value, so as to cause a second switching action of the inertial switch to the first state. Such first and second switching actions occur, during rolling of the tyre, at any passage of the crown portion corresponding to the position of the sensor device under the contact patch, i.e. at any rotation of the tyre. A simple electronics may be added to an electrical circuit connected to the inertial switch in order to perform the desired monitoring: for example, a counter may be added in order to count tyre revolutions. The inertial switch may be also used for battery management, since it is able to detect the resting status of a vehicle.

In a first aspect, the invention relates to a method for monitoring at least one dynamic parameter of a pneumatic tyre, comprising:
providing said tyre with a sensor device located in a crown portion thereof, said sensor device including an inertial switch;
rotating said tyre on a ground surface, so as to cause a first switching action of said inertial switch from a first state to a second state when said crown portion begins contacting said ground surface, and a second switching action from said second state to said first state when said crown portion looses contact with said ground surface;
determining said at least one dynamic parameter from a signal obtained from said first and second switching actions of said inertial switch.

Said dynamic parameter may preferably be the number of revolutions of said tyre.

The step of determining the number of tyre revolutions preferably comprises storing said number of tyre revolutions.

The step of rotating preferably comprises allowing a flow of electrical energy within said sensor device when said inertial switch is in said first state and interrupting said flow when said inertial switch is in said second state.

The method according to the invention may further comprise the step of sensing an internal pressure of said tyre.

The method according to the invention may further comprise the step of sensing an internal temperature of said tyre.

In a second aspect, the invention relates to a pneumatic tyre comprising:
a sensor device for monitoring one or more dynamic parameters of the pneumatic tyre, the sensor device being located in a crown portion of said tyre, the sensor device including an inertial switch being adapted to activate a first switching from a first state to a second state when said crown portion begins contacting a ground surface, and a second switching from said second state to said first state when said crown portion looses contact with said ground surface, and
a detecting device operatively connected to said inertial switch, said detecting device being adapted to determine said at least one dynamic parameter from a signal obtained from said first and second switching actions of said inertial switch.

Preferably, said sensor device is secured to an inner liner of said tyre.

Preferably, said detecting device includes a counter for counting a number of tyre revolutions based on said first and second switching of said inertial switch. Said detecting device preferably includes a memory connected to said counter for storing said number of tyre revolutions.

Preferably, said sensor device includes a battery. More preferably, said battery is connected to said inertial switch.

Preferably, said sensor device includes a pressure sensor.

Preferably, said sensor device includes a temperature sensor.

Preferably, said inertial switch has a threshold not higher than 40 g. More preferably, said inertial switch has a threshold not higher than 20 g.

Further features and advantages of the present invention will be better illustrated by the following detailed description of an example thereof, herein given with reference to the enclosed drawings, in which:

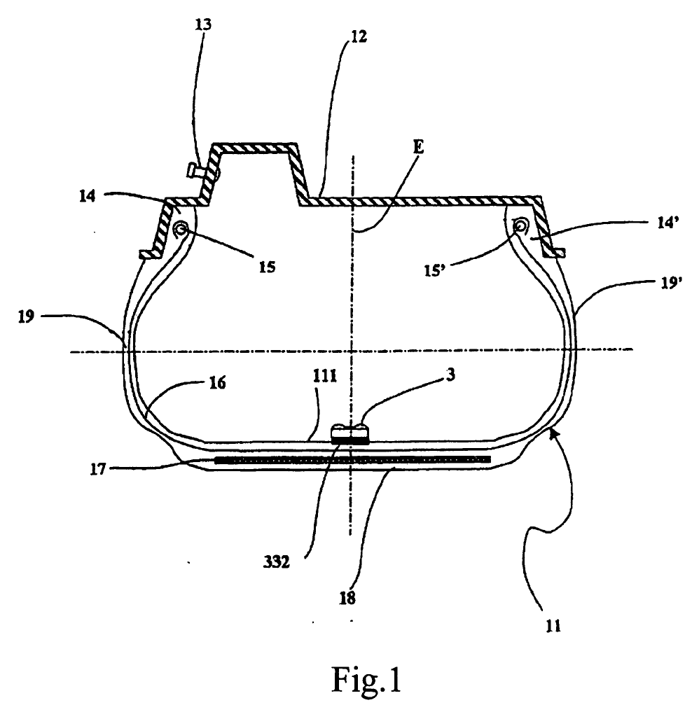

FIG. 1 shows a cross section of a tyre including a sensor device according to the invention;

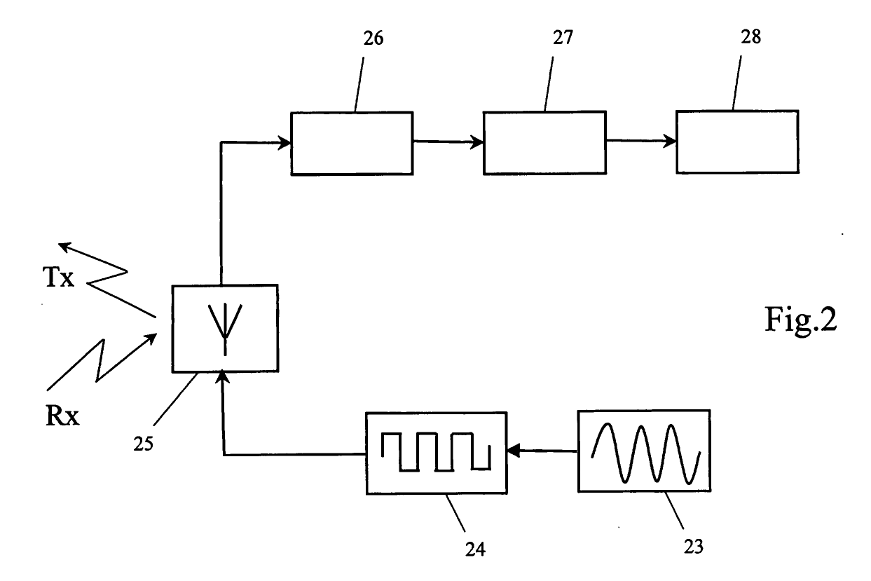

FIG. 2 shows a diagram of a fixed unit included in an apparatus according to the invention;

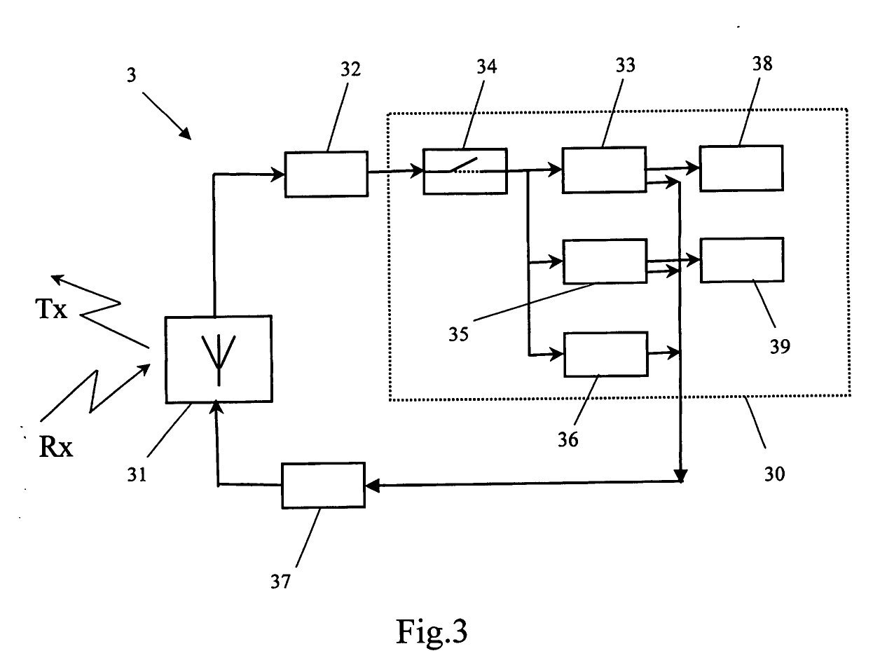

FIG. 3 shows a diagram of a sensor device included in an apparatus according to the invention;

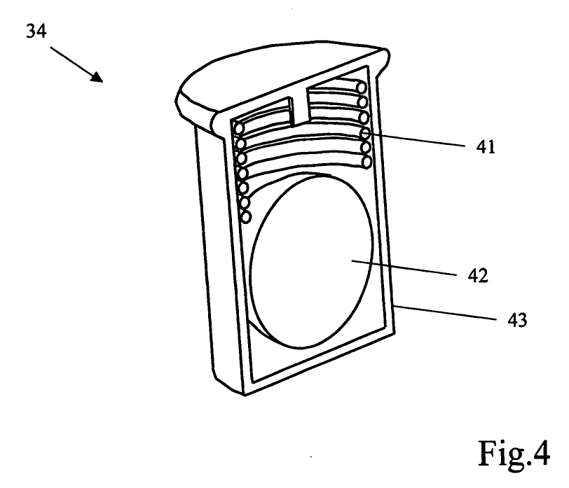

FIG. 4 shows a cross section of an exemplary inertial switch;

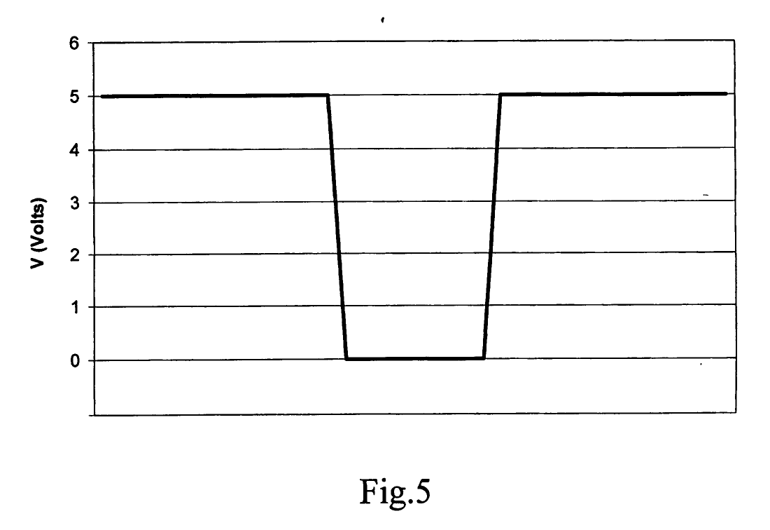

FIG. 5 shows a signal obtainable by switching actions of an inertial switch included in a sensor device disposed within a tyre, according to the invention;

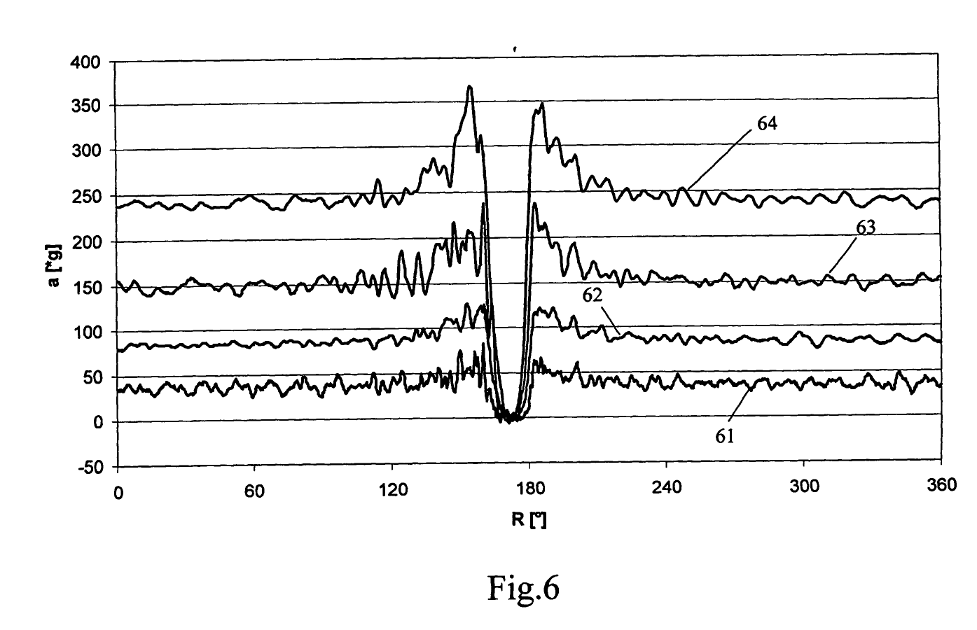

FIG. 6 shows the result of a series of measurements obtained with an accelerometer secured to the inner liner of a rolling tyre, according to the prior art.

FIG. 1 shows a cross section of a wheel comprising a tyre 11 and a supporting rim 12. The tyre 11 shown in FIG. 1 is of a type conventionally known as “tubeless”, i.e. it does not include an inner tube. This tyre can be inflated by means of an inflation valve 13 positioned, for example, on the channel of the said rim 12.

The tyre 11 includes a carcass 16, terminating in two beads 14 and 14′, each formed along an inner circumferential edge of the carcass 16, for fixing the tyre 11 to the corresponding supporting rim 12. The beads 14, 14′ comprise respective reinforcing annular cores 15 and 15′, known as bead cores. The carcass 16 is formed by at least one reinforcing ply, including textile or metallic cords, extending axially from one bead 14 to the other 14′ in a toroidal profile, and having its ends associated with a respective bead core 15 and 15′. In tyres of the type known as radial, the aforesaid cords lie essentially in planes containing the axis of rotation of the tyre. An annular structure 17, known as belt structure, is placed in crown of the carcass 16. Typically, the belt structure 17 includes one or more strips of elastomeric material incorporating metal and/or textile cords, overlapping with each other. A tread band 18 of elastomeric material is wound around the belt structure 17 and impressed with a relief pattern for the rolling contact of the tyre with the ground. Two sidewalls 19 and 19′ of elastomeric material, each extending radially outwards from the outer edge of the corresponding bead 14 and 14′, are also placed on the carcass 16 in axially opposed lateral positions. In tubeless tyres the inner surface of the carcass 16 is normally covered with a liner 111, i.e. with one or more layers of air-impermeable elastomeric material. Other known elements, such as for example bead fillers may be provided, according to the specific design of the tyre 11.

The apparatus for monitoring the dynamic parameter or parameters of the tyre 11 according to the invention comprises a sensor device 3, included within the tyre 11, which will be described in detail in the following. A useful dynamic parameter that can be monitored by the sensor device 3 is the number of revolutions of the tyre 11. However, other dynamic parameters can be monitored instead of or together with the number of tyre revolutions, such as for example the portion of the tyre deformed by the contact of the tyre itself with the ground during rolling. The sensor device 3 is located in a crown portion of the tyre 11. In the preferred embodiment shown in FIG. 1, the sensor device 3 is secured to the inner liner 111 of the tyre 11. A fixing element 332 adheres both to the sensor device 3 and to the inner liner 111. Suitable materials for the fixing element 332 may include generally flexible rubbers, such as for example natural rubber, or synthetic rubber, e.g. rubbers made from conjugated dienes having from 4 to 10 carbon atoms such as poly-isoprene, polybutadiene, styrene-butadiene rubber and the like. The material of the fixing element 332 may preferably have a Shore A hardness of from about 50 to 100. If a greater adhesion between the sensor device 3 and the tyre 11 is required, it may be advantageous to interpose a further adhesive element, for example a double-sided adhesive film, between the fixing element 332 and the inner surface of the tyre 11 and/or between the fixing element 332 and the sensor device 3. An appropriate double-sided adhesive film may be the Scotch® 300SL HI Strength, marketed by 3M. The sensor device 3 is adapted to communicate with a unit external to the tyre 11, typically located on the vehicle on which the tyre 11 is mounted. Alternatively, such unit may be a hand-held unit, or a unit located along a roadway (e.g. in a service station). Such external unit will be referred in the following as “fixed” unit.

For example, FIG. 2 shows a block diagram of a fixed unit 2, comprising a device for receiving from the sensor device 3 included within the tyre. Preferably, the fixed unit 2 also comprises a device for transmitting to said sensor device 3. The receiving device may comprise a radio-frequency receiver 26 connected to a first antenna 25, referred to below as the “fixed antenna”. Preferably, the receiving device also comprises an electrical demodulator device 27. A memory 28 included in the fixed unit 2, such as for example an EPROM, can store the data received by the sensor device 3 and demodulated by the demodulator 27. The transmission device preferably comprises an oscillator circuit 23, which supplies a driver circuit 24 for the antenna 25. If the fixed unit 2 is located on the vehicle, the electrical energy required to power the fixed unit 2 can be supplied directly by the vehicle battery.

The sensor device 3, an exemplary block diagram of which is shown in FIG. 3, comprises in general terms a device 37 for transmission to the said fixed unit and a device 30 for measuring the monitored parameter or parameters of the tyre 11. The sensor device 3 usually includes also an antenna 31, referred to below as the “mobile antenna”, operatively connected to said transmission device 37 and measuring device 30. The transmission device 37 comprises a reading circuit, which can receive signals from said measuring device 30. Such signals are then fed to the antenna 31, for transmission to the fixed unit 2. The transmission of data may occur at specified time intervals, for example every five minutes. An enabling circuit 32 may be optionally interposed between the antenna 31 and the measuring device 30, in order to enable measurements when requested by a fixed unit 2 located on the vehicle. A power source allows to energize the sensor device 3. Preferably, the sensor device 3 is powered by a battery. Alternatively, the sensor device 3 can also contain a self-powering device, which generates electricity as a result of the mechanical stresses to which said sensor device 3 is subjected (for example, centrifugal force, or the deformations of the liner, or movements due to traveling on uneven roads). As an example, piezoelectric materials may be used for such purpose. As a further alternative, the sensor device 3 may be also energized by the fixed unit by means of a suitable receiving device, connected to the mobile antenna 31 and to an electrical energy storage circuit.

The measurement device 30 includes an inertial switch 34. For the purposes of the present invention, by “inertial switch” it has to be intended a switch capable of opening or closing an electrical circuit when subjected to an acceleration greater than a threshold level. For example, a section of a mechanical inertial switch 34 is shown in FIG. 4, and may comprise a support frame 43, including an inertial element 42, suspended by a compliant spring 41, and separated from the support frame 43 by an air gap. The element 42 can itself be electrically conductive, or it can be rendered conductive, for example by using a covering metal strip. An acceleration greater than the threshold of the switch causes the element 42 to move, so as to contact the frame 43. In such way, an electrical circuit can be closed. On the contrary, the electrical circuit is left open when the element 42 is subjected to an acceleration lower than the threshold level. Such threshold level is a function of the mass of the inertial element 42, the constant of the spring 41 and the air-gap dimension separating the contacts on the inertial element 41 from the frame 43. The closing and the opening of an electrical circuit connected to the inertial switch 34 may be activated in the opposite way with respect to what said above, i.e. the electrical contact may be closed when the spring is not deflected and opened when the spring is deflected. Furthermore, different types of inertial switches, other than mechanical inertial switches, can be exploited for the purposes of the invention, such as for example mercury inertial switches making contact with a circuit at a given acceleration above the threshold, or microelectronic inertial switches realized on semiconductor or glass substrates.

The inertial switch 34 is operatively connected to the electrical source or circuit providing electrical power to the sensor device 3. More particularly, the inertial switch 34 is disposed within the sensor device 3 so as to be triggered by the absence or by the presence of radial centrifugal acceleration during rolling of the tyre. For the purposes of the present invention, by “absence of centrifugal acceleration” it has to be intended a centrifugal acceleration below the threshold of the inertial switch. For the purposes of the present invention, by “presence of centrifugal acceleration” it has to be intended a centrifugal acceleration at least equal to the threshold of the inertial switch. As it will be explained in the following, the inertial switch included in the sensor device 3 allows the measurement of the dynamic parameter of the tyre to be monitored, based on the above mentioned triggering caused by the presence and the absence of radial centrifugal acceleration to which the inertial switch is subjected during rolling of the tyre. In order to perform the desired measurement, the threshold of the inertial switch included in the sensor device 3 may preferably be not higher than 40 g, wherein g is the gravity acceleration (i.e., about 9.8 m/s²). More preferably, such threshold may be not higher than 20 g. Furthermore, in order to perform the desired measurement, the inertial switch 34 is operatively connected to a detecting device 36. For example, in order to count tyre revolutions, the detecting device may comprise an integrated logic such as a TTL (Transistor Transistor Logic) and a counter. A memory, such as for example an EPROM, can be preferably included in the detecting device 36. The detecting device 36 is connected to the transmission device 37, so that the latter can pass the information received by the detecting device to the above described fixed unit 2 (for example at specified time intervals).

In operation, the tyre 11 including the sensor 3 located in a crown portion thereof is rotated. The inertial switch 34 included in the sensor 3 is triggered by the passage of such crown portion on the ground. More particularly, the inertial switch 34 activates a first switching action when the crown portion begins contacting the ground, due to the fact that the centrifugal acceleration acting on the inertial element of the inertial switch 34 drops from a high value to a substantially null value. Then, the inertial switch 34 activates a second switching action when the crown portion looses contact with the ground, due to the fact that the centrifugal acceleration acting on the inertial element of the inertial switch 34 raises from a substantially null value to a high value. The first and the second switching actions can be respectively, for example, the opening and the closing of an electrical circuit connected to the inertial switch, in which an electrical energy provided by a battery (or other power source used for energizing the sensor device) is flowing. The opening of the circuit, occurring when the crown portion corresponding to the sensor begins passage under the contact patch, interrupts the flow of electrical energy; the closing of the circuit, occurring when the crown portion corresponding to the sensor ends passage under the contact patch, restores the flow of electrical energy. For example, FIG. 5 shows a voltage signal versus time obtained by the Applicant in a measurement performed by securing a sensor to the inner liner of a tyre model Pirelli® P6000® 195/65 R15, inflated at a pressure of 2.2 bar, with a load of 3500 N. The sensor included an inertial switch according to the invention, connected to a battery providing a voltage of 5 V. A signal having an opposite behavior with respect to that shown in FIG. 5, i.e. a “pulsed” signal having a value different from zero in correspondence of the passage of the sensor device under the contact patch and a zero value in any other situation, can be alternatively obtained. Based on this simple signal, the desired measurements can be performed in the detecting device 36. As an example, the number of tyre revolutions can be determined with a simple electronics, by counting the number of times that the “drop” (or the “pulse”) occurs in the signal exiting the inertial switch, due to absence of centrifugal acceleration. As another example, the width of the dropped portion of the signal (or the width of the pulse) can be used for evaluating the length of the tyre portion deformed by the contact of the tyre with the ground. The rotation speed of the tyre may also be determined by a measure of the width of the dropped portion (or the width of the pulse): more particularly, the higher the speed, the lower the width of the dropped portion (or of the pulse).

In order to count tyre revolutions, such signal can be transmitted to an integrated logic such as a TTL (Transistor Transistor Logic) and subsequently to a counter. The TTL transforms the input signal in an output digital signal having value ‘1’ in presence of a drop (or of a pulse), and having value “0” in any other case. The counter can then count the number of “1” in the digital signal and, optionally, stores the number into a memory included within the sensor, such as for example an EPROM. Alternatively or additionally, such number can be stored in a memory included in the fixed unit, in particular if the fixed unit is located on the vehicle carrying the monitored tyre. Such number typically increases an already stored number, corresponding to previous revolutions already carried out. The number of tyre revolutions can be then used to determine the distance traveled by the tyre, the radius of the tyre being known. In case of use of a memory both within the sensor 3 and within the fixed unit 2, the information stored within the memory of the sensor, including the number of tyre revolutions, may be periodically transmitted to the fixed unit 2 for storing into its memory. Then, the memory included in the sensor 3 may be erased.

Advantageously, in an active sensor device, including a battery, the inertial switch 34 may also be used for battery management, since it can detect the resting status of a vehicle. In this case, the desired monitoring can be performed with no necessity of using a dedicated device. Alternatively, two different inertial switches can be used, a first one for performing the monitoring, a second one for detecting the resting status. In both cases, a very simple, cheap, reliable and effective sensor device capable of measuring dynamic parameters of a tyre, such as the number of tyre revolutions, can be implemented for insertion within the tyre. Referring again to FIG. 3, the measuring device 30 included within the sensor device 3 may preferably also comprise at least one driver circuit, and/or encoder/decoder circuit, for at least one measuring sensor for other characteristic parameters of the tyre. In particular, the example in FIG. 3 shows two further driver circuits 33 and 35 for two sensors 38 and 39, namely a first sensor 38 for measuring the inflation pressure of the tyre and a second sensor 39 for measuring the temperature inside the tyre. Alternatively, a single driver circuit encodes and/or decodes the pressure and/or temperature signal generated by a single sensor. These sensors can be sensors for measuring an absolute value of pressure or temperature, or can be threshold sensors, i.e. sensors capable of signaling a departure from a previously specified threshold value of pressure and/or temperature. Within the sensor device 3, the pressure and temperature signals can be suitably encoded for their transmission outside the tyre; for example, they can be associated with an identification code of the tyre, in order to avoid confusion with similar signals originating from the other tyres of the vehicle.

FIG. 6 shows, for comparison, the result of a series of measurements performed by the Applicant by securing an accelerometer to the inner liner of a tyre model Pirelli® P6000® 195/65 R15, inflated at a pressure of 2.2 bar, with a load of 3500 N. A rolling of the tyre was caused at different speeds and the radial centrifugal acceleration detected by the accelerometer was correspondingly plotted. In FIG. 6, the rotation angle R around the tyre axis of the crown portion corresponding to the accelerometer position is reported in abscissa. The angle ranges from 0° to 360°, these two extremes corresponding substantially to a radially opposite position with respect to the contact patch. On the contrary, the position around 180° corresponds to the passage of the crown portion monitored by the accelerometer under the contact patch. The centrifugal acceleration a sensed by the accelerometer is reported in ordinate, as a multiple of g, i.e. the gravity acceleration. Curve 61 refers to a traveling speed of 40 km/h, curve 62 refers to a traveling speed of 60 km/h, curve 63 refers to a traveling speed of 80 km/h, curve 64 refers to a traveling speed of 100 km/h. As it can be seen, in correspondence to the passage under the contact patch the level of radial centrifugal acceleration sensed by the accelerometer drops to until substantially zero, whereas in other positions the radial acceleration sensed by the accelerometer has a level related to the rotation speed of the rolling tyre: the higher the speed, the higher the sensed acceleration.

However, FIG. 6 also shows that the signal obtained by the accelerometer is a typical analogical signal, having many variations not related to the above described drop caused by the passage of the crown portion monitored by the accelerometer under the contact patch. Thus, in order to obtain a “cleaned” signal showing only such drop, a suitable electronics should be added, with an increase in complexity.

1-16. (canceled)

17. A method for monitoring one or more dynamic parameters of a pneumatic tyre, comprising:
providing the tyre with a sensor device disposed in a crown portion of the tyre;
rotating the tyre on a ground surface; and
determining the one or more dynamic parameters of the tyre;
wherein the sensor device comprises an inertial switch,
wherein the inertial switch changes from a first state to a second state when the crown portion begins contacting the ground surface,
wherein the inertial switch changes from the second state to the first state when the crown portion loses contact with the ground surface, and
wherein the one or more dynamic parameters of the tyre are determined from a signal obtained from the changes of the inertial switch.

18. The method of claim 17, wherein the one or more dynamic parameters comprises a number of revolutions of the tyre.

19. The method of claim 18, wherein determining the number of revolutions of the tyre comprises:
storing the number of revolutions of the tyre.

20. The method of claim 17, wherein rotating the tyre on the ground surface comprises:
allowing a flow of electrical energy within the sensor device when the inertial switch is in the first state; and
interrupting the flow of electrical energy within the sensor device when the inertia switch is in the second state.

21. The method of claim 17, further comprising:
sensing an internal pressure of the tyre.

22. The method of claim 17, further comprising:
sensing an internal temperature of the tyre.

23. A pneumatic tyre, comprising:
a sensor device for monitoring one or more dynamic parameters of the tyre; and
a detecting device;
wherein the sensor device is disposed in a crown portion of the tyre,
wherein the sensor device comprises an inertial switch,
wherein the inertial switch changes from a first state to a second state when the crown portion begins contacting a ground surface,
wherein the inertial switch changes from the second state to the first state when the crown portion loses contact with the ground surface,
wherein the detecting device is operatively connected to the inertial switch, and
wherein the detecting device determines the one or more dynamic parameters of the tyre from a signal obtained from the changes of the inertial switch.

24. The tyre of claim 23, wherein the detecting device comprises:
a counter;
wherein the counter counts a number of tyre revolutions based on the changes of the inertial switch.

25. The tyre of claim 24, wherein the counter counts the number of tyre revolutions based on the changes of the inertial switch from the first state to the second state.

26. The tyre of claim 24, wherein the detecting device further comprises:
a memory;
wherein the memory is connected to the counter, and
wherein the memory stores the number of tyre revolutions.

27. The tyre of claim 23, wherein the sensor device is secured to an inner liner of the tyre.

28. The tyre of claim 27, wherein the detecting device comprises:
a counter;
wherein the counter counts a number of tyre revolutions based on the changes of the inertial switch.

29. The tyre of claim 28, wherein the counter counts a number of tyre revolutions based on the changes of the inertial switch from the first state to the second state.

30. The tyre of claim 28, wherein the detecting device further comprises:
a memory;
wherein the memory is connected to the counter, and
wherein the memory stores the number of tyre revolutions.

31. The tyre of claim 23, wherein the sensor device further comprises:
a battery.

32. The tyre of claim 31, wherein the battery is operatively connected to the inertial switch.

33. The tyre of claim 23, wherein the sensor device further comprises:
a pressure sensor.

34. The tyre of claim 23, wherein the sensor device further comprises:
a temperature sensor.

35. The tyre of claim 23, wherein the inertia switch has a threshold not higher than 40 times acceleration due to gravity.

36. The tyre of claim 23, wherein the inertial switch has a threshold not higher than 20 times acceleration due to gravity.
